(19) United States
(12) Patent Application Publication
(10) Pub. No.: US 2021/0331897 A1
(43) Pub. Date: Oct. 28, 2021

(54) BELT END TERMINATION FOR A BELT COMPRISING A PLURALITY OF LOAD CARRIERS

(71) Applicant: thyssenkrupp Elevator Innovation and Operations GmbH, Essen (DE)

(72) Inventor: Frank Dudde, Collierville, TN (US)

(73) Assignee: thyssenkrupp Elevator Innovation and Operations GmbH, Essen (DE)

(21) Appl. No.: 16/857,429

(22) Filed: Apr. 24, 2020

(51) Int. Cl. B66B 7/08; B66B 7/12

(52) U.S. Cl. CPC B66B 7/085; B66B 7/1223

(57) ABSTRACT

A belt end connector configured to be attached to a terminal end of an elevator belt. The terminal end includes a plurality of exposed conductive load carrier strands. The belt end connector includes a connector housing, an adapter assembly, a plug including a spring mechanism and an electric outlet. The belt end connector is configured to be removable from the belt.

### FIELD

The invention refers to a belt end connector configured to be attached to a terminal end of an elevator belt. The terminal end includes a plurality of exposed conductive load carrier strands.

The invention also refers to a method of assembling and disassembling a belt end connector to a terminal end of an elevator belt that is part of an elevator system.

### BACKGROUND

US 2016 0221796 A1 discloses an end termination that provides a conductive connection with one or more load bearing member without damaging the rope. This rope terminal arrangement comprises a terminal block mounted immovably on an end of a rope of an elevator wherein said block comprises a contact arrangement to establish an electrical connection with one or more load-bearing member. The contact arrangement comprises a plurality of connectors which are each spring based against the load bearing members. In order to cover as much of the surface of the load bearing member as possible and thereby improve the quality of the electrical connection, more connectors are needed. Due to the limited surface area available on the rope and the limited space available on the contact arrangement, an optimal electrical connection is not possible. Furthermore, an exposed surface area of the load bearing member can remain when the rope terminal arrangement has been attached to the rope. This can cause contamination of the electrical contact surface.

### SUMMARY

It is an object of the invention, to provide a solution to the above, in particular, to provide an alternative way of electrically contacting the load carrier strands comprised within a belt or rope. Moreover, the invention provides an easier way to carry this out, wherein the integrity of the load carrier strands is not compromised by possible external contamination.

This object is solved by a belt end connector according to the disclosure.

The invention provides a belt end connector configured to be attached to a terminal end of an elevator belt, wherein the terminal end includes a plurality of exposed conductive load carrier strands the belt end connector including a connector housing, an adapter assembly, and a plug including a spring mechanism and an electric outlet. This advantageously allows for a connection of the belt end connector to an external electrical device. The belt end connector according to the invention is characterized in that it is configured to be removable from the belt. This advantageously provides a belt end connector that can be used and then removed as necessary. It also provides a belt end connector that can be easily used with a replacement belt in the event one or more belt fails or breaks or suffers from wear. This belt end connector also provides a reliable way of establishing an electrical connection between the load carrier strands comprised within a belt or rope, the belt end connector and one or more external electrical device, which can provide for easier monitoring and maintenance of belts.

Another aspect of the disclosure provides a belt end connector as above, wherein, the adapter assembly includes an adapter housing, a plurality of projections wherein each projection is conductive, and a conductive material. The conductive material may include a plurality of conductive blocks. The blocks may have a Young's modulus between 5 and 100 MPa, preferably between 20 and 40 MPa. The conductive material may be configured to respond to an applied pressure e.g. via deformation. This advantageously provides a conductive material that can reliably cover at least a portion of the surface area of the terminal end of the belt, including the area comprising one or more exposed load carrier strand, wherein the coverage can increase with an applied pressure, consequently, improving the electrical connection quality.

Yet another aspect of the disclosure provides a belt end connector according to the above, wherein the conductive material is configured to contact at least one of the exposed conductive load carrier strands. The conductive material may contact each exposed conductive load carrier strand. This advantageously ensures that the cross-section of each load carrier strand is reliably covered by the conductive material, thereby improving the electrical contact there between and mitigating any risks of surface-area discrepancies.

Another aspect of the belt end connector according to the above provides that each projection within the plurality of projections is separated from an adjacent projection by the conductive material. The conductive material may be squeezed in between the projections to ensure a tight fit and thereby good electrical contact between the load carrier strands and the projections.

Another aspect of the belt end connector according to the above provides that the distance between each projection may be at least between 0.5 mm to 60 mm, preferably between 1 mm and 10 mm. The preferred distance may ultimately depend on the transversal belt cross-section dimensions and the load carrier dimensions. The distance includes the conductive material. This advantageously ensures that as large a conductive surface area as possible is provided to cover the load carrier strands.

Yet another aspect of the invention provides a belt end connector according to the above wherein the conductive material is selected from one or more of the following: copper, aluminum, silver, zinc, graphite, conductive polymer(s), or any alloy of one or more of the above-mentioned metals.

Yet another aspect of the invention provides a belt end connector according to the above wherein each projection includes a non-conductive core, a first conductive coating, at least one further conductive coating, wherein the first conductive coating is applied to a first side of the non-conductive core and the at least one further conductive coating is applied to a second side of the non-conductive core.

Further, the belt end connector may provide wherein the first conductive coating and the at least one further conductive coating are electrically isolated, i.e., each conductive block is not electrically connected with any other conductive block. This advantageously ensures that the electric current is confined to travelling towards the projections. The adapter assembly may be disposed within the housing. The housing may include a fastener which is adapted to switch between a locked and an unlocked position. This advantageously ensures that the housing can be removed from the belt when necessary. The fastener may be adapted to contact the plug at the spring mechanism when in its locked position, and when moving into said locked position.

Preferably, the fastener or fastening means, when contacting the plug exerts a pressure onto a spring mechanism, e.g., a leaf spring, disposed on the exterior of the plug. This advantageously ensures that the plug is pressed into the adapter assembly comprised within the housing, thereby holding the adapter assembly and the plug securely in place within the housing. The plug may include a plurality of receiver slots, wherein each slot comprises an electrical contact and is adapted to receive one protrusion from the plurality of protrusions. This advantageously establishes an electrical connection between the load carrier strands and the plug. The electrical outlet of the plug may be adapted to be electrically connected to the plurality of receiver slots via the plurality of electrical contacts. This advantageously establishes an electrical connection between the load carrier strands and the plug.

The invention contemplates a method for assembling and disassembling a belt end connector to a terminal end of an elevator belt comprised within an elevator system, the terminal end including a plurality of exposed conductive load carrier strands, wherein the belt end connector includes a connector housing, an adapter assembly, a plug including a spring mechanism and an electric outlet. This advantageously allows for connection of the belt end connector to an external electrical device. In one aspect, the method includes feeding the belt through the housing, attaching at the terminal end of the belt a first auxiliary strip to a top surface of the belt and a second auxiliary strip to a bottom surface of the belt. Preferably, the auxiliary strips are wedge shaped. The wedges preferably extend along a longitudinal length section of the belt and across a width section of the belt. Preferably the wedges extend across the complete width of the belt.

A first terminal end of the each respective wedge may contact the housing and a second terminal end of each respective wedge may contact the adapter. Each wedge may have a length that allows for the adapter assembly to be comprised within the housing to such an extent that it is contactable by the plug and remains in place when a pressure is applied thereto during the process of moving the fastening means from its unlocked position to its locked position. The wedges also advantageously help provide a seal between the housing and the belt, thereby pushing the housing over the wedges such that the terminal end and the auxiliary strips are comprised therein. The wedges advantageously help provide a seal between the housing and the belt as well as an electrical connection to the belt surface and can provide for example, electrostatic discharge by inserting the adapter assembly into the housing such that it contacts the plurality of exposed conductive load carrier strands and preferably also the auxiliary strips, connecting the plug to the adapter assembly, in particular to the adapter housing such that it is at least partially comprised within the housing. This advantageously maintains the integrity of the load carrier strands by moving the fastening means from an unlocked position to a locked position, thereby applying a pressure to the spring mechanism of the plug.

This advantageously provides a belt end connector with improved integrity of the load carrier strands since they are completely contained within the housing and completely covered by the adapter and the plug, thus ensuring that they are not compromised by possible external contamination. The wedges also ensure that no foreign matter can enter the housing from the belt side. Therefore, the electrical connection between the load carrier strands and any external device connected to the plug at its electrical outlet is of the highest quality.

The method may include wherein disassembling the belt end connector comprises performing the lo method steps in the reverse order. The method may further include connecting an external electrical device to the electrical outlet. The method may include wherein the first and second auxiliary strips are comprised of a conductive material. Preferably the first and second auxiliary strips include copper, aluminum, silver, zinc, graphite, conductive polymer(s), any alloy of one or more of the above-mentioned metals, or any combination of one or more of the above.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a belt end termination according to the disclosure.

FIG. 2 is a perspective view of a belt end termination according to the disclosure.

FIG. 3 is a perspective view of a belt end termination according to the disclosure.

FIG. 4a is a schematic representation of component parts comprised within a belt end termination according to the disclosure.

FIG. 4b is a schematic representation of component parts comprised within a belt end termination according to the disclosure.

FIG. 5 is an exploded perspective view of a belt end termination according to the disclosure.

FIG. 6 is a simplified 2D schematic representation of a belt end termination according to the disclosure when electrically disconnected.

FIG. 7 is a simplified 2D schematic representation of a belt end termination according to the disclosure when electrically connected.

FIG. 8 is a simplified 2D schematic representation of a belt end termination according to the disclosure detailing the signal flow from the load carrier to the electrical outlet.

FIG. 9 is a schematic representation of a vertical cross-section view of a belt end termination according to the disclosure.

### DETAILED DESCRIPTION

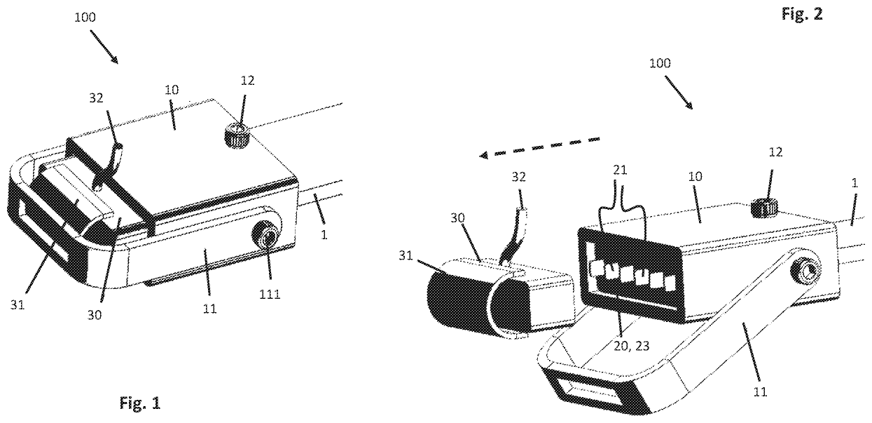

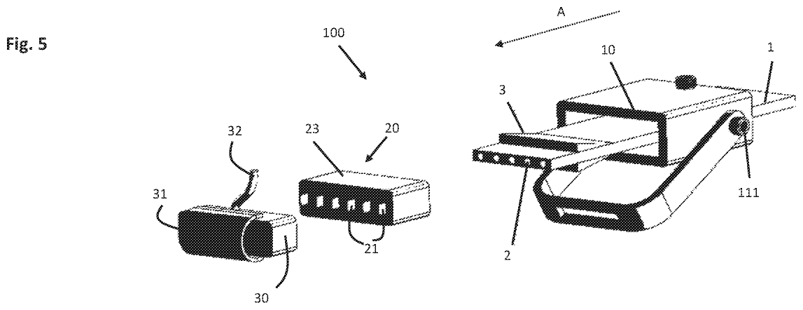

In FIG. 1 a belt end connector 100 according to the disclosure is shown. The belt end connector 100 comprises a connector housing 10, an adapter 20 (not shown) and a plug 30. The belt end connector 100 is connected to a terminal end of a belt 1 via the housing 10 (shown more clearly in FIG. 5). The end connector 100 shown is in a locked position and is ready to send and receive signals from the load carriers 2 (not shown) comprised within the belt 1.

The housing 10 is made from a conductive material e.g., aluminum or any other suitable conductive metal or metal alloy, and comprises a fastening means 11 which is adapted to switch between a locked and an unlocked position. The housing 10 is electrically grounded via a ground connector 12 to shield the end connector 100 from electrostatic loads and electric disturbances. In this example, the fastening means 11 is a clip, which is rotationally affixed to the housing 10 at joint 111. The clip 11 is locked when it is parallel to the housing 10 and unlocked when no longer parallel to said housing 10 (see FIG. 2).

The plug 30 comprises a leaf spring 31 and an electric outlet 32. In this example, the electric outlet 32 is an electrical supply and signal cable. The cable 32 provides for an electrical connection between the end termination 100 and any external device. The plug 30 is comprised between the clip 11 and the adapter assembly 20 which is comprised within the body of the housing 10 (shown in FIG. 2). The clip 11 when in its locked position, compresses the leaf spring 31 which pushes the plug 30 further into the adapter assembly 20 within the housing 10, thereby holding the plug 30 in place.

FIG. 2 shows the end connector 100 of FIG. 1 in its unlocked position. When unlocked, the plug 30 is removed from the housing 10 (in the direction of the arrow) and thus becomes disconnected from the adapter assembly 20 comprised therein. The adapter assembly 20 comprises a plurality of projections 21, a plurality of conductive blocks 22 (see FIGS. 4a and 4b) and an adapter housing 23. The projections 21 are adapted to maintain a distance between the adapter assembly 20 and the belt terminal (not shown in FIG. 2) and to be part of the electrical connection between at least one load carrier 2 (not shown) and the plug 30.

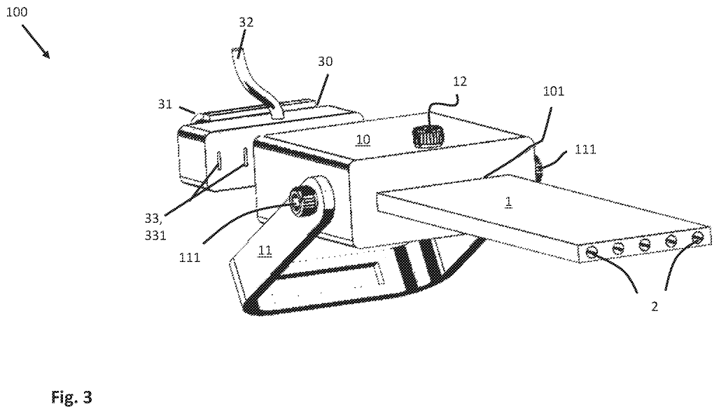

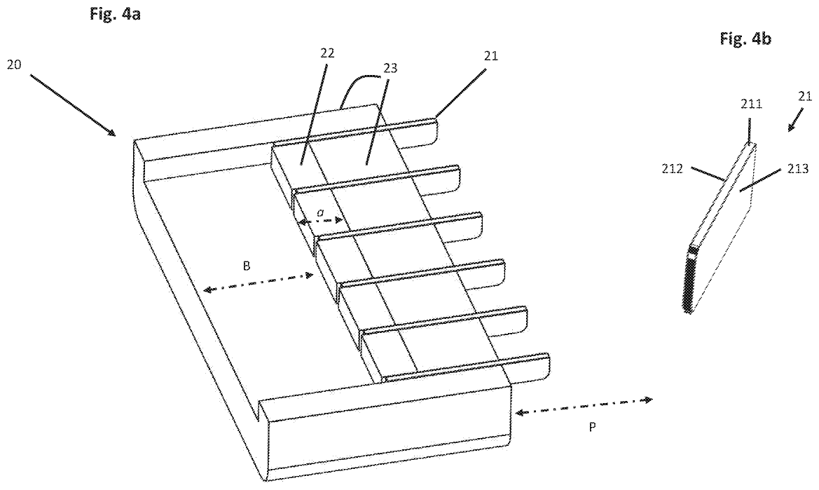

FIG. 3 shows the end connector 100 of FIG. 2 from a different perspective. Notable in this example, is that the presence of the receiver slots 33 can now be seen. The receiver slots 33 receive the protrusions 21 when the plug is pressed onto the adapter 20. The receiver slots 33 are complementary in shape to the protrusions in order to ensure as good an electrical connection as possible between the adapter assembly 20 and the plug 30. The receiver slots 33 each comprise an electrical contact 331 (not shown) which serve to establish an electrical connection between the inserted protrusions 21 and the electrical outlet 32.

FIGS. 4a and 4b show the adapter assembly 20 in more detail. FIG. 4a shows the adapter assembly 20 comprising the adapter housing 23, the projections 21 and the plurality of conductive blocks 22, wherein each block 22 comprises a conductive material 22. The plurality of projections 21 are separated by a conductive block 22 pressed there between such that each block 22 is connected to two projections 21. In this example, the conductive material 22 comprises a polymer. The section marked “B” represents the area where the belt 1 is comprised. The section marked “P” represents the side of the adapter 20 which receives the plug 30.

FIG. 4b shows a single projection 21. The projection 21 comprises a non-conductive core 211, a first conductive coating 212 on a first side of the non-conductive core and a second conductive coating 213 on a second side of the non-conductive core. The conductive coatings 212, 213 are electrically isolated from each other.

FIG. 5 shows the belt end connector 100 from the previous figures when dismantled thus showing how the component parts are interconnected. Looking first at the belt 1, in this particular example, it comprises a plurality of load carrier strands 2 configured in a single row. It is also possible to have a belt 1 with multiple rows and/or having a plurality of load carrier strands 2 or a single load carrier optionally divided in sections in any desired configuration. In such a case, the adapter assembly 20 would be re-configured to match this belt orientation. For example, with a unidirectional carbon fiber load carrier having one load carrier body throughout its cross-section, wherein each carbon fiber is surrounded by a non-conductive material, it is possible to configure the assembly 20 to address a first part of the cross section and separately a further one or more part(s) of the same cross-section.

The belt 1 is fed through the housing 10 in the direction shown by arrow A, until a length emerges which is sufficient to allow the attachment of the adapter assembly 20 and at least two auxiliary strips 3.

The two auxiliary strips 3, in this particular example are wedges 3 and they are attached to the outermost top and bottom surface of the belt 1 once it is sufficiently fed through the housing 10. The wedges 3 are arranged and clamped between the housing 10 and the belt 1. The wedges 3 preferably comprise a conductive material e.g. copper or aluminum, or any other suitable conductive material which provides a good electrical connection between the belt 1 and the housing 10. The wedges 3 can also be adhered to the polymer material of the belt 1. The wedges 3 form part of a locking mechanism when they interact with the adapter assembly 20 and the plug 30, in particular the leaf spring 31 and the housing 10, in particular the clip 11. This locking mechanism ensures a good mechanical connection between the housing 10 and belt 1 whilst also providing a good electrical contact between the load carrier strands 2, the belt end connector 100 and thereby the belt surface and the belt end connector 100. The wedges 3 clamped between the housing 10 and the belt 1, can also optionally serve as an arresting means for when the adapter assembly 20 is inserted onto the belt 1.

The housing 10 is pushed over the wedges 3 so that the terminal end of the belt 1 and the wedges 3 are tightly comprised within the housing body 10 (see FIG. 2). Pushing the housing 10 over the wedges 3 and then pushing the adapter housing 20 against the wedges serves to pre-lock the housing 10 in the longitudinal direction. Next, the adapter assembly 20 is inserted, followed by the plug 30. Pressing the plug 30 onto the adapter assembly 20 increases the pressure between the protrusions 21 and the belt terminal surface comprising the load carrier strands 2 and creates an electrical connection between the load carrier strands 2 and the electric outlet 32 via the protrusions 21.

To secure the belt 1, adapter assembly 20 and plug 30 and to further improve all electrical connections, the clip 11 is rotated about the joint 111 from its unlocked position until it reaches its locked position in parallel with the housing 10 as shown in FIG. 1. The end connector 100 is now ready to send and receive signals from the load carriers 2 comprised within the belt 1.

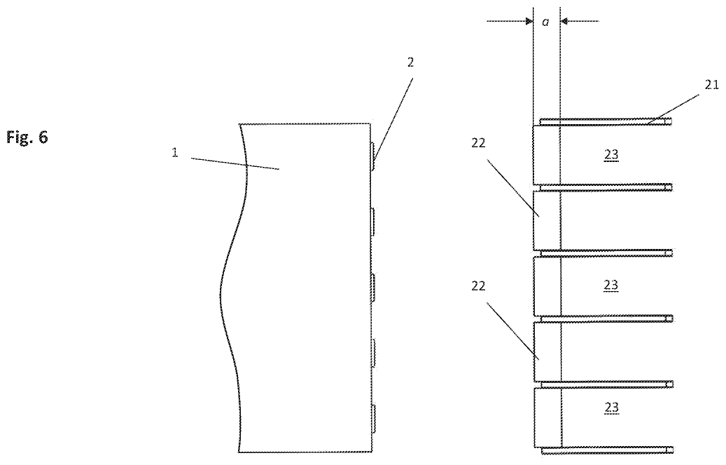

FIG. 6 shows the conductive blocks 22 and the protrusions 21 of the adapter assembly 20 when not engaged with the load carrier strands 2 comprised within the belt 1. In this particular example, the conductive blocks 22 are soft and have a thickness “a” in the range between 3 mm and 6 mm such that they can reliably cover the cross section of each load carrier strand 2 comprised within the belt 1. The blocks 22 are squeezed between the projections 21, ensuring a tight fit and thereby good electrical contact. This also ensures a reliable electrical connection to the load carrier strands 2.

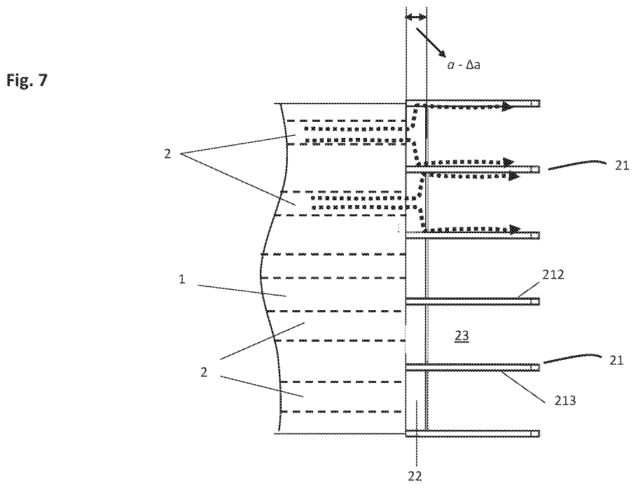

FIG. 7 shows the conductive blocks 22 and the protrusions 21 of the adapter assembly 20 when engaged with the load carrier strands 2 comprised within the belt 1. In this particular example, all protrusions 21 contact the terminal end of the belt 1 and all conductive blocks 22 contact the load carrier strands 2. The blocks 22 are compressed by the pressure applied from the leaf spring 31 (not shown) of the plug 30 and further compressed when the clip 11 (not shown) is in a locked position. This compression is represented by the value “Δa”. When compressed, the conductive blocks 22 have a resulting thickness of “a-Δa”. The dotted lines represent flow of electrical current between the load carrier strands 2 and the projections 21.

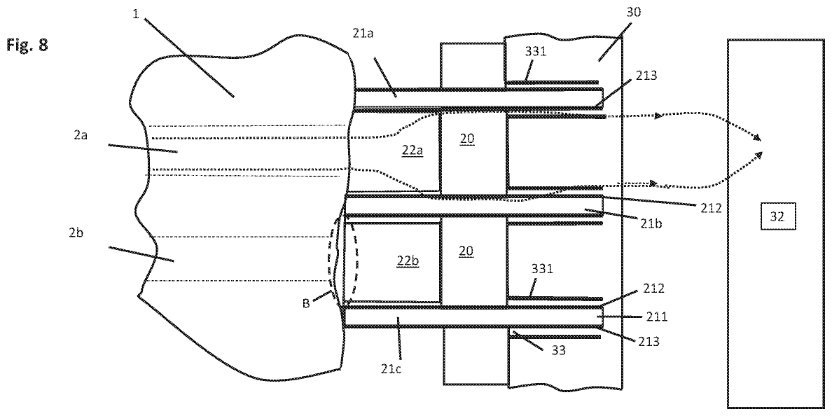

FIG. 8 shows a more detailed view of the current flow between the load carrier strands 2a, 2b and the electrical contacts 331 comprised within the receiver slots 33 of the plug 30. In this particular example, the belt 1 has an uneven surface at its terminal end such that only one projection 21a fully contacts the terminal surface of the belt 1 whilst projections 21b and 21c only partially contact the belt 1. The conductive block 22a fully contacts the load carrier strand 2a, whilst the conductive block 22b remains at a distance from the load carrier strand 2b, as shown by the encircled area B. When this occurs, an average compression “Δa” of the conductive blocks 22 is calculated instead of an absolute value—as would be calculated in the example provided in FIG. 7.

The current flows from the load carrier strand 2a through the conductive block 22a and through the conductive coating 213, 212 on the projections 21a and 21b. Whilst current can flow through both coatings 212, 213 of a projection 21, in this particular example, current flows through the coating 213 of projection 21a and coating 212 of projection 21b. The current reaches the electrical contacts 331 comprised within the receiver slots 33 of the plug 30. The electrical contacts 331 are shown as traversing the length of the receiver slot 33, however this is merely for illustration purpose. In reality, the electrical contact 331 can be any length within the receiver slot 33. The electrical signal travels from the electrical contacts 331 to the cable 32. FIGS. 7 and 8 show that there is always two paths that the electrical signal from one load carrier strand 2 can follow. Therefore if one projection 21 happens to be faulty, e.g., 21a, the other projection, e.g., 21b can still provide a pathway for the electrical signal. This improves the electrical reliability of the electrical connection.

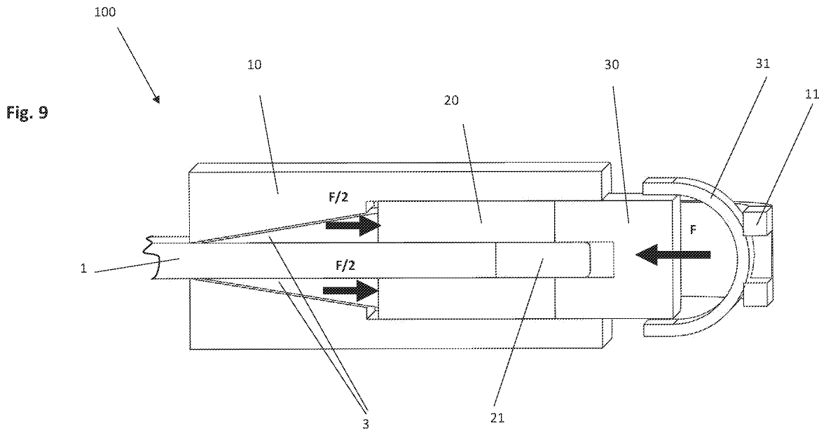

FIG. 9 shows the forces at play when the belt end connector 100 is in a locked state. The leaf spring force F and the counter forces F/2 of the wedges 3 are balanced and ensure that the housing 10 is clamped to the belt 1. The adapter assembly 20 is pressed against the terminal end of the belt 1 (the load carrier strands 2 are not shown) whilst the plug 30 is pressed against the adapter and held in place via the clip 11 in its locked orientation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements.

Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A belt end connector configured to attach to a terminal end of an elevator belt, the terminal end comprising a plurality of exposed conductive load carrier strands, the belt end connector comprising:
a connector housing;
an adapter assembly; and
a plug comprising:
a spring mechanism; and
an electric outlet;
wherein the belt end connector is configured to be removable from the belt.

2. The belt end connector of claim 1 wherein the adapter assembly comprises:
an adapter housing; and
a plurality of projections;
wherein each projection includes a conductive material and is conductive.

3. The belt end connector of claim 2 wherein the conductive material is configured to contact at least one of the exposed conductive load carrier strands.

4. The belt end connector of claim 2 wherein each projection within the plurality of projections is separated from an adjacent projection by the conductive material.

5. The belt end connector of claim 4 wherein the distance between each projection is at least between 0.5 mm to 60 mm wherein said distance comprises the conductive material.

6. The belt end connector of claim 2 wherein the conductive material is one or more of copper, aluminum, or conductive polymer.

7. The belt end connector of claim 2 wherein each projection comprises:
a non-conductive core;
a first conductive coating; and
at least one further conductive coating;
wherein the first conductive coating is applied to a first side of the non-conductive core and the at least one further conductive coating is applied to a second side of the non-conductive core.

8. The belt end connector of claim 7 wherein the first conductive coating and the at least one further conductive coating are electrically isolated.

9. The belt end connector of claim 1 wherein the adapter assembly is comprised within the housing.

10. The belt end connector of claim 1 wherein the housing comprises a fastener that is adapted to switch between a locked and an unlocked position.

11. The belt end connector of claim 10 wherein the fastener is adapted to contact the plug at the spring mechanism when in its locked position, and when moving into said locked position.

12. The belt end connector of claim 1 wherein the plug comprises a plurality of receiver slots, wherein each slot comprises an electrical contact and is adapted to receive one protrusion of the plurality of protrusions.

13. The belt end connector of claim 1 wherein the electrical outlet is configured to be electrically connected to the plurality of receiver slots via the plurality of electrical contacts.

14. A method for assembling and disassembling a belt end connector to a terminal end of an elevator belt of an elevator system, said terminal end comprising a plurality of exposed conductive load carrier strands, wherein the belt end connector comprises a connector housing, an adapter assembly, a plug comprising a spring mechanism and an electric outlet, wherein
the method comprises:
a. feeding the belt through the housing;
b. attaching at the terminal end of the belt a first auxiliary strip to a top surface of the belt and a second auxiliary strip to a bottom surface of the belt;
c. pushing the housing over the wedges such that the terminal end and the auxiliary strips are comprised therein;
d. inserting the adapter assembly into the housing such that it contacts the plurality of exposed conductive load carrier strands;
e. connecting the plug to the adapter assembly such that it is at least partially comprised within the housing; and
f. moving the fastening means from an unlocked position to a locked position, thereby applying a pressure to the spring mechanism of the plug.

15. The method of claim 14 wherein disassembling the belt end connector comprises performing the method steps in the reverse order of step f to step a.

16. The method of claim 14 further comprising connecting an external electrical device to the electrical outlet.

17. The method of claim 14 wherein the first and second auxiliary strips include a conductive material.
